(19) United States
(12) Patent Application Publication
(10) Pub. No.: US 2026/0230401 A1
(43) Pub. Date: Aug. 6, 2026

(54) PERFORMANCE MONITORING FOR AI/ML MODELS IN WIRELESS COMMUNICATION SYSTEMS

(71) Applicant: Samsung Electronics Co., Ltd., Gyeonggi-do (KR)

(72) Inventors: Yuan-sheng CHENG, San Diego, CA (US); Mohamed AWADIN, San Diego, CA (US); Hamid SABER, San Diego, CA (US); Liang HU, San Diego, CA (US); Jung Hyun BAE, San Diego, CA (US)

(21) Appl. No.: 19/446,351

(22) Filed: Jan. 12, 2026

Related U.S. Application Data
(60) Provisional application No. 63/754,845, filed on Feb. 6, 2025.

(51) Int. Cl. H04L 41/16; H04B 7/06; H04W 24/10

(52) U.S. Cl. CPC H04L 41/16; H04B 7/06952; H04W 24/10

(57) ABSTRACT

A method is provided, the method including: receiving a configuration identifying a monitoring window including a plurality of monitoring resource instants; obtaining measurements of reference signals transmitted at the monitoring resource instants; associating each of the monitoring resource instants with at least one inference result produced by an artificial-intelligence or machine-learning model; determining a performance metric by comparing information based on the inference result with information based on the measurements of the monitoring resource instants; and transmitting the performance metric in a performance monitoring report.

### CROSS-REFERENCE TO RELATED APPLICATION

This application claims the priority benefit under 35 U.S.C. § 119(e) of U.S. Provisional Application No. 63/754,845, filed on February 6, 2025, the disclosure of which is incorporated by reference in its entirety as if fully set forth herein.

### TECHNICAL FIELD

The disclosure generally relates to wireless communication systems. More particularly, the subject matter disclosed herein relates to improvements to performance monitoring of artificial-intelligence (AI) or machine-learning (ML) models using signal measurements.

### SUMMARY

Wireless communication systems increasingly utilize AI/ML models to improve operations such as link adaptation, resource selection, and beam management. These models often generate inference results that guide device behavior based on predicted channel conditions or signal characteristics.

To solve this problem, previous solutions have relied on periodic measurements, predefined reporting structures, or offline validation techniques to estimate how well an AI/ML model is performing. Such approaches typically use aggregated or historical data rather than real-time information tied to specific resource instants.

One issue with the above approach is that it does not provide a reliable indication of inference accuracy under dynamic radio conditions. In particular, certain methods do not associate model outputs with corresponding measurements collected at resource instants, making it difficult to evaluate performance with sufficient precision.

To overcome these issues, systems and methods are described herein for monitoring performance of an AI/ML model by configuring a monitoring window, obtaining measurements at resource instants, associating those instants with inference results, determining a performance metric based on comparing information based on the inference results and information based on the measurements, and reporting the performance metric for evaluation.

The above approaches improve on previous methods because they provide real-time, measurement-based performance monitoring, enable accurate assessment of model behavior in changing radio environments, and facilitate more effective management and adaptation of AI/ML models in wireless communication systems.

In an embodiment, a method comprises receiving a configuration identifying a monitoring window comprising a plurality of monitoring resource instants; obtaining measurements of reference signals transmitted at the monitoring resource instants; associating each of the monitoring resource instants with at least one inference result produced by an AI or ML model; determining a performance metric by comparing information based on the inference result with information based on the measurements of the monitoring resource instants; and transmitting the performance metric in a performance monitoring report.

In an embodiment, a UE comprises at least one processor and at least one memory storing instructions that, when executed by the at least one processor, cause the UE to: receive a configuration identifying a monitoring window comprising a plurality of monitoring resource instants; obtain measurements of reference signals transmitted at the monitoring resource instants; associate each of the monitoring resource instants with at least one inference result produced by an AI or ML model; determine a performance metric by comparing information based on the inference result with information based on the measurements; and transmit the performance metric in a performance monitoring report.

In an embodiment, a system comprises a network node configured to: provide a configuration identifying a monitoring window comprising a plurality of monitoring resource instants to a UE; receive measurements of reference signals obtained by the UE at the monitoring resource instants; receive at least one inference result produced by an AI or ML model executed at the UE; receive a performance monitoring report containing a performance metric determined by the UE based on comparing information based on the inference result with information based on the measurements; and process the performance metric to evaluate performance of the AI or ML model.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example wireless communication system including a UE and a base station (gNB) in communication with each other, according to an embodiment;

FIG. 2 illustrates an example monitoring window and the time-domain relationship between monitoring resource instants and a monitoring report instant, according to an embodiment;

FIG. 3 illustrates an example association between monitoring resource instants within the window of FIG. 2 and inference resource instants for determining a performance metric, according to an embodiment;

FIG. 4 illustrates an example flowchart of a method for monitoring performance of an AI or ML model in a wireless communication system, according to an embodiment; and

FIG. 5 illustrates a block diagram of an example electronic device in which the systems and methods described herein may be implemented, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

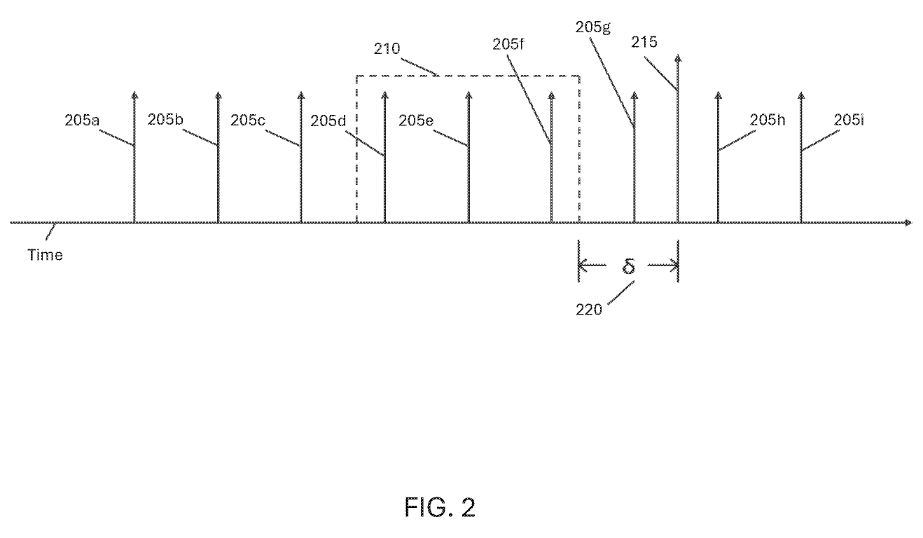

“Configuration” as used herein may refer to information provided to a device that specifies operational parameters for performing one or more procedures described in this disclosure. Some examples of “configuration” may include signaling that identifies a monitoring window and its monitoring resource instants, a window size, a reference monitoring instant, a reporting offset, a set of beams or resources to be measured, an identifier of an AI or ML model or inference resource set, or one or more rules for associating measurements with inference results. In some embodiments, a maximum number of monitoring resource instants supported by a UE may be subject to UE capability signaling. For example, the UE may transmit a UE capability report indicating a maximum monitoring window size, a maximum number of monitoring resource instants, or supported monitoring configurations. The network node may configure the monitoring window based on the reported UE capability. In some embodiments, UE capability signaling may further indicate processing-related capabilities associated with performance monitoring, such as a maximum number of inference results that can be associated with a monitoring resource instant, or supported capabilities for ranking or evaluating subsets of inference results when determining performance metrics. “Monitoring window” as used herein may refer to a time interval or grouping of monitoring resource instants that are used to obtain measurements of reference signals for use in performance monitoring of an AI or ML model. Some examples of “monitoring window” may include a window defined by a configured number of monitoring resource instants (e.g., M instants such as 205d-205f in FIG. 2), a window that identifies a reference monitoring resource instant for aligning measurement timing with inference timing, a sliding window that shifts over time as new monitoring resource instants occur, or a window associated with a reporting offset that specifies when a performance-monitoring report is to be generated. “Monitoring resource instant” as used herein may refer to a point in time (e.g., a specific time of transmission or reception), at which a device is configured to obtain a measurement of one or more reference signals for use in performance monitoring. Some examples of “monitoring resource instant” may include a time instant (e.g., 205a-205i in FIG. 2) associated with a reference-signal transmission, a slot or symbol at which the UE measures reference signal received power (RSRP) or other signal-quality metrics, or a configured element within a monitoring window used to generate ground-truth measurement values. “Measurements of reference signals” as used herein may refer to signal-quality or signal-strength values obtained by a device in response to receiving one or more reference signals transmitted by a network node or other transmitter. Some examples of “measurements of reference signals” may include measurements such as RSRP, reference signal received quality (RSRQ), signal-to-interference-plus-noise ratio (SINR), received signal strength indicator (RSSI), beam-specific RSRP measurements for identified beams or antenna ports, or any measurement based on channel-state-information (CSI)-RS, synchronization signal block (SSB), or other downlink reference-signal resources configured for monitoring.

“Inference result” as used herein may refer to an output generated by an AI or ML model based on input features, historical data, or real-time measurements, where the output is intended to predict, classify, rank, or estimate one or more communication-related parameters. Some examples of “inference result” may include predicted beam indices, predicted top-N beam sets, predicted channel-quality indicators, predicted beam-rankings, probability scores for one or more candidate beams, predicted antenna-port selections, predicted link adaptation parameters, or other prediction values produced at inference resource instants (e.g., 305a-305j) or within an inference resource set (e.g., 315a-315c). “AI or ML model” as used herein may refer to a computational model that uses AI or ML techniques to generate predictions, classifications, rankings, or other inference outputs based on input features, historical data, or real-time measurements. Some examples of “AI or ML model” may include neural networks (e.g., deep neural networks, recurrent neural networks, long short-term memory networks), tree-based models (e.g., random forests, gradient-boosted decision trees), regression-based models, clustering-based models, reinforcement-learning models, or hybrid architectures configured to predict beam indices, rank beams, estimate channel states, or produce other inference results at inference resource instants or within inference resource sets. “Performance metric” as used herein may refer to an indicator that reflects how accurately or effectively an AI or ML model performs relative to actual measurements obtained at monitoring resource instants. Some examples of “performance metric” may include: beam-accuracy indicator (BAI) representing whether a predicted beam matches a measured beam; top-M / top-N consistency checks, such as whether a set of top-M predicted beams falls within a set of top-N measured beams; or prediction-error indicators, including whether a predicted beam falls outside a configured subset of beams used for monitoring.

“Performance monitoring report” as used herein may refer to a message, indication, or signaling report transmitted by a UE or other device that conveys one or more performance metrics reflecting the accuracy or effectiveness of an AI or ML model. Some examples of “performance monitoring report” may include: a CSI performance-monitoring report that includes a BAI, prediction-error counts, or other beam-level performance indicators; a report containing a top-M / top-N consistency result, such as whether predicted beams fall within the measured beam set; or a report including aggregated or statistical performance metrics (e.g., averages, distributions, hit/miss results) collected over a monitoring window. “Beam-accuracy indicator (BAI)” as used herein may refer to a metric or flag that indicates whether a predicted beam generated by an AI or ML model corresponds to a beam determined from measurements obtained at one or more monitoring resource instants. Some examples of “beam-accuracy indicator (BAI)” may include: a binary indicator (e.g., 1 = match, 0 = no match) showing whether the top predicted beam equals the measured strongest beam; a multi-level indicator representing degrees of match (e.g., exact match, within a ranked margin, within a configured subset of beams); or a numerical score reflecting the difference between the predicted beam index and the measured beam index. “Top-M / top-N predicted beam sets” as used herein may refer to ranked subsets of beams selected from, respectively, the prediction output of an AI or ML model (top-M) and the measured beam results obtained at one or more monitoring resource instants (top-N). Some examples of “top-M / top-N predicted beam sets” may include: a top-M predicted beam set that includes the M beams with the highest predicted ranking scores from the AI/ML model (e.g., M = 1, 2, 4); or a top-N measured beam set generated by ranking beams based on measured signal strength or reference signal received power at a monitoring resource instant (e.g., N = 4, 8, 16).

In some embodiments, parameters used for determining performance metrics may be configured by a network node or determined by the UE based on configuration information. For example, values of M and N used for evaluating top-M predicted beams relative to top-N measured beams may be provided via signaling, predefined profiles, or configuration rules, and may be fixed or dynamically adjusted over time. Similarly, a subset of beams used for monitoring may be defined by configuration information identifying candidate beams, beam groups, or beam indices to be considered for performance evaluation, such as beams measured on configured reference signal resources. In some embodiments, such configuration may be provided via higher-layer signaling, physical-layer control signaling, or preconfigured rules stored at the UE.

The embodiments described herein provide mechanisms for monitoring the performance of an AI or ML model used within a wireless communication device. A network node may configure a UE with a monitoring window that identifies a set of monitoring resource instants. The UE may obtain measurements of reference signals transmitted at these instants and associate each monitoring instant with one or more inference results produced by the AI/ML model. By comparing information based on the inference results with information based on the measurements, the UE can determine a performance metric that reflects the accuracy or effectiveness of the model under current radio conditions.

The UE may then transmit the performance metric in a performance-monitoring report to the network node, enabling real-time evaluation of AI/ML model behavior. These techniques allow the system to assess model performance with fine temporal granularity, support model adaptation or selection, and provide a robust framework for managing AI/ML-based functions in wireless communication environments. The embodiments described below illustrate example implementations of these operations in greater detail.

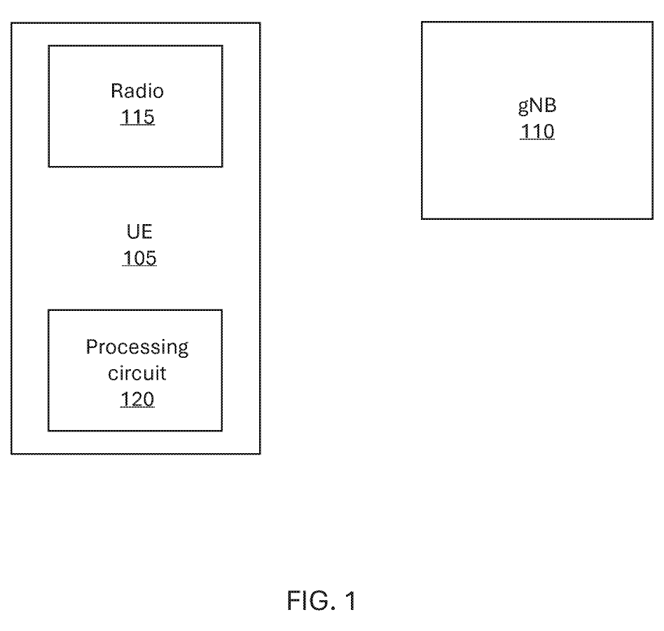

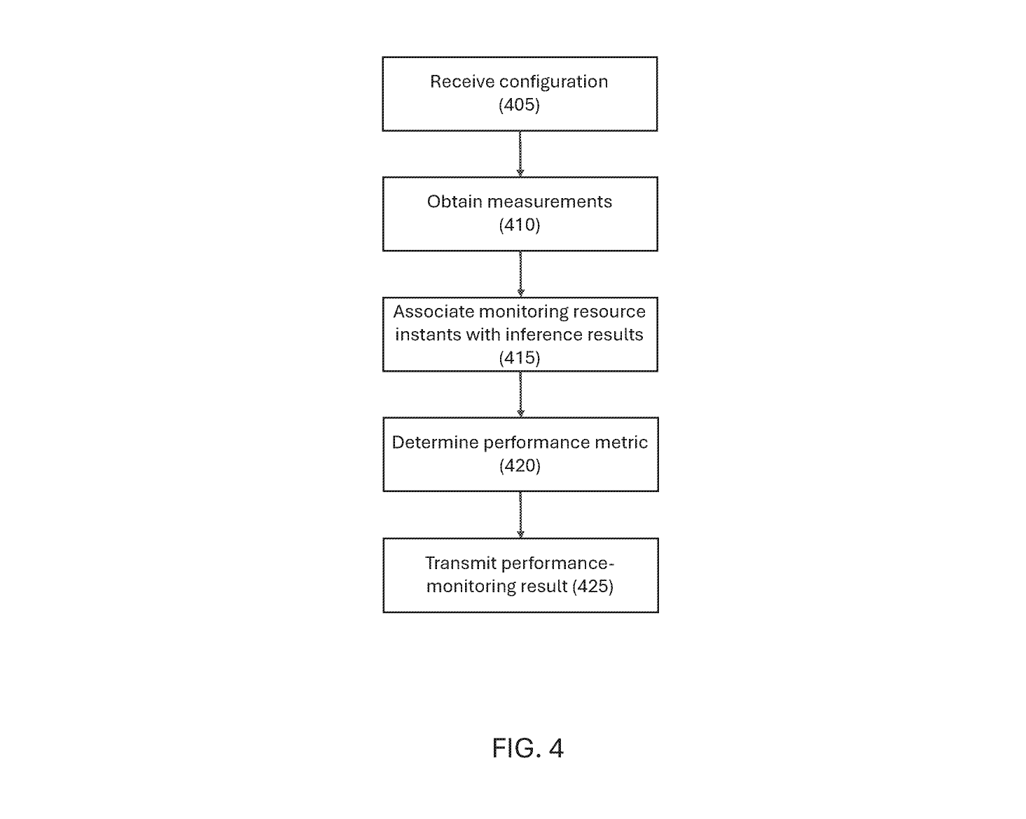

FIG. 1 illustrates an example wireless communication system that may include a UE 105 and a gNB 110 in communication with each other, according to an embodiment. The UE 105 may include a radio 115 configured to transmit and receive wireless signals, and a processing circuit (or means for processing) 120 configured to perform various operations described herein, including the method illustrated in FIG. 4. For example, the processing circuit 120 may receive, via the radio 115, downlink reference signals or configuration information from the gNB 110, and the processing circuit 120 may transmit, via the radio 115, performance-monitoring reports or other uplink signals to the gNB 110. In some embodiments, the processing circuit 120 may obtain measurements at monitoring resource instants, associate the measurements with inference results produced by an AI or ML model, determine a performance metric based on the comparison, and cause the UE 105 to report the resulting metric to the gNB 110. Although a single UE and gNB are shown for simplicity, additional UEs, network nodes, or network elements may be present in other embodiments.

FIG. 2 illustrates an example time-domain relationship between monitoring resource instants and a corresponding monitoring report instant, according to an embodiment. As shown, a plurality of monitoring resource instants 205a-205i may occur in sequence over time. Each of the monitoring resource instants 205a-205i may correspond to a time at which the UE 105 obtains a measurement of one or more reference signals for use in performance monitoring. Although nine monitoring resource instants are depicted for clarity, any number of instants may be used depending on configuration provided by the network.

In the example of FIG. 2, a monitoring window 210 is shown that includes a subset of the monitoring resource instants. In this embodiment, the monitoring window 210 includes three monitoring resource instants (e.g., 205d, 205e, and 205f), corresponding to a window size M = 3. The monitoring window 210 may be identified by a configuration received from a network node, and may specify which monitoring resource instants are to be used for evaluating performance of an AI or ML model. The monitoring window 210 may include any number of monitoring resource instants, as defined by configuration, and the window size M is not limited to the illustrated example. In some embodiments, the monitoring resource instants included in the monitoring window may be contiguous in time, while in other embodiments the monitoring resource instants may be non-contiguous or selected according to a predefined rule or pattern. Within the monitoring window 210, a particular monitoring resource instant, such as instant 205f, may be designated as a reference monitoring resource instant for aligning measurements with one or more inference results produced by the AI or ML model. In some embodiments, one or more monitoring resource instants within the monitoring window 210 may serve as reference monitoring resource instants for establishing a temporal relationship between measurements and inference results.

A monitoring report instant 215 is shown occurring after the monitoring window 210. At the monitoring report instant 215, the UE 105 may transmit a performance-monitoring report that includes a performance metric determined from measurements obtained at one or more of the monitoring resource instants within the monitoring window 210. A time interval 220 (δ) is illustrated between a boundary of the monitoring window 210 and the monitoring report instant 215. In some embodiments, the interval 220 may represent a reporting offset or timing gap between the final monitoring resource instant used for measurement and the instant at which the performance-monitoring report is generated or transmitted. This offset may account for processing time, scheduling constraints, or reporting procedures associated with the performance-monitoring operation. By way of example and not limitation, the interval 220 (δ) may correspond to a duration on the order of one or more symbols, slots, subframes, or frames, such as on the order of a few milliseconds to tens of milliseconds, depending on processing latency, uplink scheduling, or configuration provided by the network node.

Although FIG. 2 depicts a specific example with a window size of three monitoring resource instants and a single reference instant, other embodiments may utilize different window sizes, different configurations of monitoring resource instants, multiple reference instants, or different timing relationships between the monitoring window and the monitoring report instant.

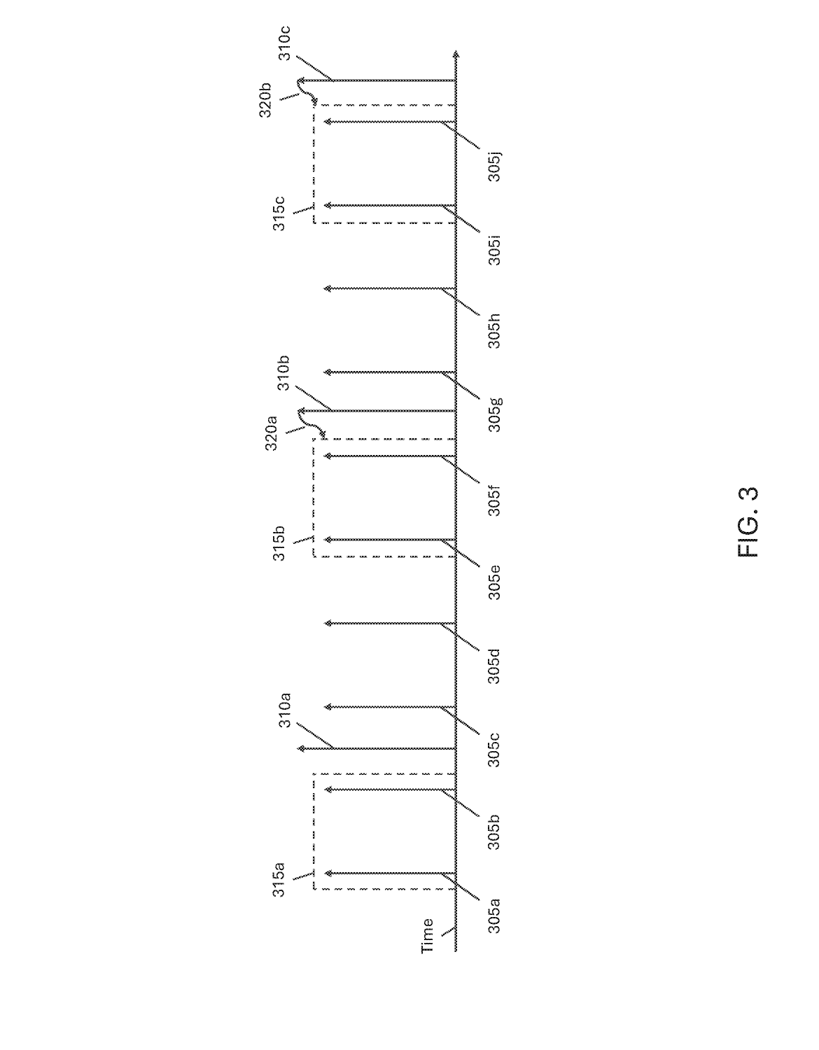

FIG. 3 illustrates an example association between monitoring resource set instants and inference resource set instants for determining a performance metric, according to an embodiment. Along a time axis, a plurality of inference resource set instants 305a-305j are shown. Each inference resource set instant 305a-305j may correspond to a time at which an AI or ML model produces one or more inference results, for example predicted beams or other prediction outputs as described elsewhere in this disclosure.

One or more dashed boxes 315a-315c are illustrated enclosing respective groups of the inference resource set instants 305a-305j. Each dashed box 315a-315c represents an inference resource set or inference window that includes multiple inference resource set instants. For example, in some embodiments an inference resource set may include two or more inference resource set instants associated with a common inference cycle or prediction context (e.g., I = 2 inference results for a given period). Although three inference resource sets 315a-315c are shown for clarity, any number of inference resource sets and any number of inference resource set instants per set may be used depending on configuration. Inference resource sets may be associated with monitoring resource instants selected by the monitoring window described with respect to FIG. 2 for purposes of determining one or more performance metrics.

Monitoring resource set instants 310a-310c are also shown along the time axis. Each monitoring resource set instant 310a-310c may correspond to a time at which a UE obtains one or more measurements of reference signals on a configured monitoring resource set, as described above in connection with the monitoring window. In the example of FIG. 3, association arrows 320a and 320b extend from monitoring resource set instants 310b and 310c, respectively, to inference resource sets 315b and 315c. Each association arrow 320a, 320b represents an association between a measurement obtained at the corresponding monitoring resource set instant and one or more inference results produced during the associated inference resource set. In some embodiments, the associated inference resource set may be selected such that an inference resource set instant within the set (e.g., 305e or 305i) is the closest in time to the monitoring resource set instant, while in other embodiments multiple inference resource set instants within the set may be used. In other embodiments, the association between a monitoring resource set instant and an inference resource set may be determined based on a configured rule, a sliding temporal window, or other association logic provided by the network node.

The associations illustrated in FIG. 3 may be used when determining a performance metric for the AI or ML model. For example, measurements obtained at monitoring resource set instants 310a-310c may be compared with inference results produced during the associated inference resource sets 315a-315c to determine a beam-accuracy indicator, to evaluate whether a top-M set of predicted beams falls within a top-N set of measured beams, or to identify cases in which predicted beams fall outside a configured subset of beams used for monitoring. Although specific temporal relationships and associations are shown in FIG. 3, other embodiments may employ different numbers of monitoring and inference resource set instants, different grouping structures, or different association rules while using the same approach of associating monitoring measurements with inference results for performance monitoring. The associations depicted in FIG. 3 may correspond, in some embodiments, to the measurements obtained in the monitoring windows illustrated in FIG. 2.

FIG. 4 illustrates a flowchart of an example method for monitoring performance of an AI or ML model in a wireless communication system, according to an embodiment. The method may be performed by the UE 105 of FIG. 1, for example by the processing circuit 120 executing one or more software modules stored in memory. Although the steps are shown in a particular order for ease of explanation, the order of the steps may be modified, steps may be combined or subdivided, and one or more steps may be repeated or omitted in other embodiments.

In step 405 (“Receive configuration”), the UE 105 may receive a configuration identifying a monitoring window comprising a plurality of monitoring resource instants. The configuration may be provided by the gNB 110 or another network node via one or more downlink signaling messages, such as higher-layer signaling or physical layer control signaling. The configuration may specify, for example, a set of time instants or slots at which the UE is to obtain measurements of reference signals, a window size M indicating a number of monitoring resource instants in the monitoring window (e.g., M = 3 as shown in FIG. 2), a reference monitoring resource instant within the window, or a reporting offset or timing constraint for transmitting a performance-monitoring report. In some embodiments, the configuration may further indicate parameters associated with an AI or ML model whose performance is to be monitored, such as an identifier of the model, an identifier of a set of inference results or inference windows (e.g., inference resource sets 315a–315c in FIG. 3), or association rules for mapping monitoring resource instants to inference results. The configuration may be received once, periodically, or updated dynamically.

In step 410 (“Obtain measurements”) , the UE 105 may obtain measurements of reference signals at the monitoring resource instants identified in the configuration. Each monitoring resource instant 205a-205i in FIG. 2 may correspond to a time at which the UE receives one or more reference signals, such as downlink reference signals used for beam management or channel estimation. In some embodiments, obtaining measurements comprises receiving one or more reference signals and performing signal measurement or estimation operations at the physical layer, such as measuring received signal power, signal quality, or interference levels associated with the reference signals. The processing circuit 120 may control the radio 115 to measure a signal quality metric (e.g., RSRP, RSRQ, SINR, or other measurement values) for one or more beams, antenna ports, or reference signal resources associated with the monitoring resource set. The obtained measurements may include, for example, beam-specific measurement values, channel quality indicators, or signal-to-interference measurements derived from reference signals such as synchronization signal blocks (SSBs), channel-state-information reference signals (CSI-RS), or other configured reference signal resources. In some embodiments, the UE may obtain measurements for a subset of beams or resources configured by the network, for example a configured subset of candidate beams used for monitoring. The resulting measurement values may be stored in memory together with timing information identifying the corresponding monitoring resource instants within the monitoring window 210.

In step 415 (“Associate monitoring resource instants with inference results”), the UE 105 can associate each monitoring resource instant with at least one inference result produced by an AI or ML model. The inference results may be generated by a model executing in the UE, in the gNB, or in another network entity, and may include, for example, predicted beams, predicted beam indices, predicted channel quality values, or other prediction outputs as described in connection with FIG. 3. In some embodiments, the inference results are produced at inference resource set instants 305a-305j, which are grouped into inference resource sets 315a-315c. For a given monitoring resource set instant 310a-310c, the UE may identify an associated inference resource set using an association rule. For example, the UE may select the inference resource set that includes an inference resource set instant that is closest in time to the monitoring resource set instant (e.g., association arrows 320a and 320b in FIG. 3). In other embodiments, the association may be based on a configured mapping table, a sliding temporal window, or a rule provided by the network, and may involve associating multiple inference resource set instants with a single monitoring resource set instant. The association results in pairs (or groups) of measurement data and inference results that are used in subsequent performance-metric calculations.

In step 420 (“Determine performance metric”) , the UE 105 may determine a performance metric by comparing information from the inference results with information from the measurements obtained at the monitoring resource instants. The performance metric may quantify how accurately the AI or ML model’s predictions correspond to the actual measured conditions. In one embodiment, the performance metric comprises a BAI that indicates whether a predicted beam output by the model matches a measured best beam determined from the reference-signal measurements. For example, the BAI may be set to “1” when the predicted beam index equals the measured top-1 beam index within the monitoring window and set to “0” otherwise. In another embodiment, the performance metric comprises a top-M/top-N accuracy indicator that specifies whether a top-M set of predicted beams falls within a top-N set of measured beams, where M and N are configured values. In a further embodiment, the performance metric may indicate whether a predicted beam falls outside a configured subset of beams used for monitoring. The performance metric may represent any numerical or categorical indicator derived from comparisons between predicted and measured values, such as an error rate over a monitoring window, a histogram of successful predictions, or an aggregated score combining multiple accuracy conditions described herein.

In step 425 (“Transmit performance-monitoring result”) , the UE 105 may transmit the determined performance metric in a performance-monitoring report. The performance-monitoring report may be transmitted at a monitoring report instant 215 as illustrated in FIG. 2, for example after a reporting offset 220 that allows the UE to complete measurement processing and metric calculation. In some embodiments, the performance-monitoring report may include one or more indicators, fields, or values representing the performance metric in a compact or structured format. For example, the report may include a binary or multi-level indicator (e.g., a beam-accuracy indicator), an index or identifier of a predicted beam, a flag indicating whether a predicted beam falls within a measured beam set, a count or ratio of successful predictions over a monitoring window, or a set of aggregated or statistical values derived from multiple monitoring resource instants. In some embodiments, the performance-monitoring report is conveyed in a CSI performance-monitoring report associated with an inference report, and may be carried on a physical uplink control channel (PUCCH), physical uplink shared channel (PUSCH), or another uplink signaling mechanism configured by the network. The report may include one or more performance metrics corresponding to different monitoring windows, different inference windows, or different AI/ML models, and may optionally include identifiers of the associated inference results or resource sets. The gNB 110 or another network entity may use the received performance-monitoring result to evaluate, select, update, or disable AI/ML models used for beam management or other radio procedures, or to adjust configuration of monitoring windows and inference resources for subsequent operation.

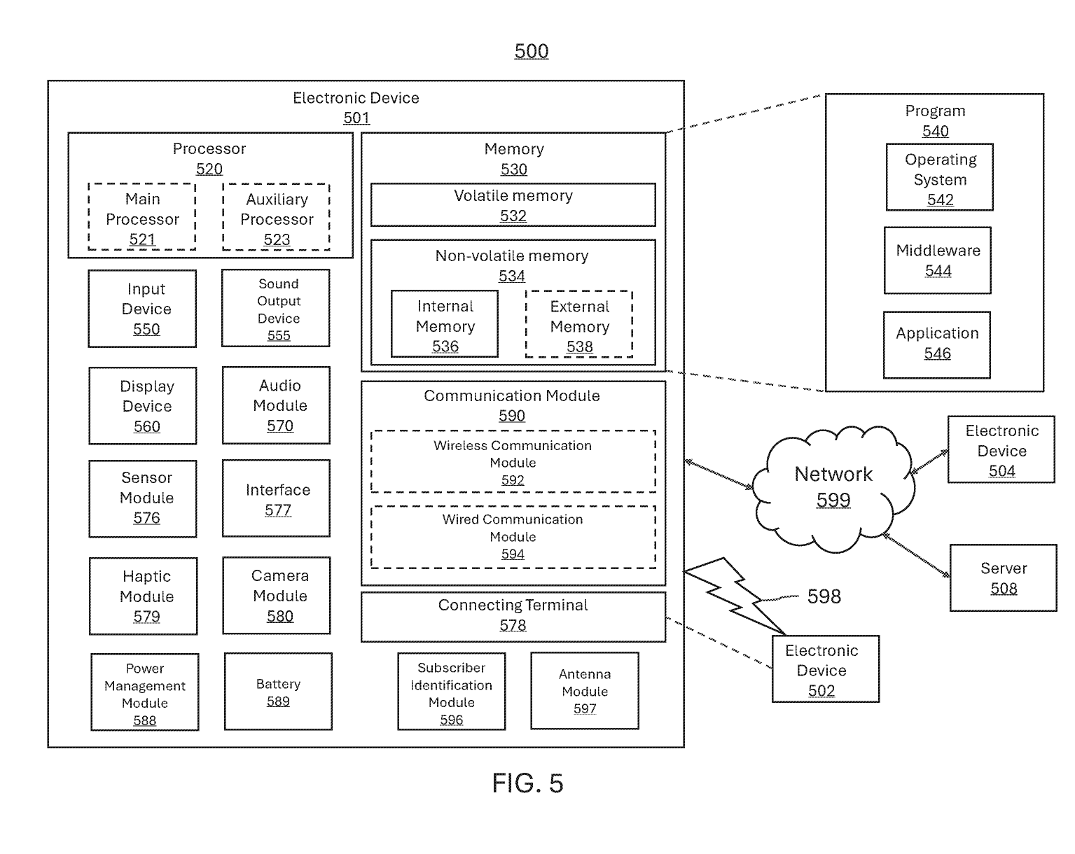

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high- definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH^{TM} , wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

The electronic device 501 of FIG. 5 may be configured to perform one or more of the operations described above in connection with FIGS. 1-4. For example, the processor 520, which may include the main processor 521 and/or the auxiliary processor 523, may execute program instructions stored in the memory 530 to implement the method illustrated in FIG. 4. In particular, the processor 520 may receive configuration information identifying a monitoring window, control the communication module 590 and antenna module 597 to obtain measurements of reference signals at monitoring resource instants, associate the measurements with inference results generated by an AI or ML model, determine a performance metric based on comparisons between the inference results and the actual measurements, and cause the electronic device 501 to transmit a performance-monitoring report to a network node via the first network 598 or second network 599. These operations correspond to the measurement and association principles described with respect to FIGS. 2 and 3, including the use of monitoring windows 210, inference resource sets 315a-315c, and association rules such as selecting the closest inference resource instant in time.

In embodiments in which the AI or ML model executes on the electronic device 501 itself, the hardware supporting the model, such as the main processor 521, auxiliary processor 523 (e.g., a GPU, DSP, NPU, or communication processor), or dedicated AI acceleration circuitry, may perform inference operations that generate predicted beams or other inference results at inference resource set instants 305a-305j. These inference results may be stored in the memory 530 and subsequently accessed during the performance-metric computation. In embodiments where inference is performed at an external device (e.g., the server 508 or another network node), the communication module 590 and antenna module 597 may receive inference results or inference reports over the second network 599, after which the local processor 520 associates these results with UE-based measurements to compute a performance metric. In either case, all or part of the method steps shown in FIG. 4 including receiving configuration information, obtaining measurements, associating monitoring and inference resource instants, computing performance metrics, and transmitting performance-monitoring results may be carried out by one or more components of the electronic device 501 shown in FIG. 5.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving a configuration identifying a monitoring window comprising a plurality of monitoring resource instants;
obtaining measurements of reference signals transmitted at the monitoring resource instants;
associating each of the monitoring resource instants with at least one inference result produced by an artificial-intelligence (AI) or machine-learning (ML) model;
determining a performance metric by comparing information based on the inference result with information based on the measurements of the monitoring resource instants; and
transmitting the performance metric in a performance monitoring report.

2. The method of claim 1, wherein the configuration identifies a number of monitoring resource instants in the monitoring window.

3. The method of claim 2, wherein the maximum number of monitoring resource instants is subject to a user equipment (UE) capability report.

4. The method of claim 1, wherein associating each monitoring resource instant with the inference result comprises selecting a closest inference resource instant in time.

5. The method of claim 1, wherein associating each monitoring resource instant with the inference result comprises selecting a closest inference report instant in time.

6. The method of claim 1, wherein associating each monitoring resource instant with an inference result comprises selecting a closest inference result time instant, when the inference results comprise beam information in multiple time instants.

7. The method of claim 1, wherein the inference result comprises predicted beam information generated by the AI or ML model.

8. The method of claim 6, wherein determining the performance metric comprises comparing predicted beam information with measured beam information obtained at the monitoring resource instants.

9. The method of claim 1, wherein determining the performance metric comprises determining a beam-accuracy indicator (BAI) based on whether a predicted beam matches a measured beam.

10. The method of claim 1, wherein determining the performance metric comprises determining whether a set of top-M predicted beams from the inference results is within a set of top-N measured beams set based on measurements obtained at the monitoring resource instants, where M and N are configured values.

11. The method of claim 1, wherein determining the performance metric comprises evaluating whether a predicted beam is outside a configured subset of beams used for monitoring.

12. The method of claim 1, wherein transmitting the performance metric comprises transmitting the performance metric in a channel-state-information (CSI) performance-monitoring report associated with an inference report.

13. A user equipment (UE) comprising at least one processor and at least one memory storing instructions that, when executed by the at least one processor, cause the UE to:
receive a configuration identifying a monitoring window comprising a plurality of monitoring resource instants;
obtain measurements of reference signals transmitted at the monitoring resource instants;
associate each of the monitoring resource instants with at least one inference result produced by an artificial-intelligence (AI) or machine-learning (ML) model;
determine a performance metric by comparing information based on the inference result with information based on the measurements; and
transmit the performance metric in a performance monitoring report.

14. The UE of claim 13, wherein the configuration identifies a number of monitoring resource instants in the monitoring window.

15. The UE of claim 13, wherein associating each monitoring resource instant with the inference result comprises selecting a closest inference resource instant in time that precedes or coincides with the monitoring resource instant.

16. The UE of claim 13, wherein associating each monitoring resource instant with the inference result comprises selecting a closest inference report instant in time.

17. The UE of claim 13, wherein determining the performance metric comprises determining a beam-accuracy indicator (BAI) based on whether a predicted beam matches a measured beam.

18. A system comprising a network node configured to:
provide a configuration identifying a monitoring window comprising a plurality of monitoring resource instants to a user equipment (UE);
receive measurements of reference signals obtained by the UE at the monitoring resource instants;
receive at least one inference result produced by an artificial-intelligence (AI) or machine-learning (ML) model executed at the UE;
receive a performance monitoring report containing a performance metric determined by the UE based on comparing information based on the inference result with information based on the measurements; and
process the performance metric to evaluate performance of the AI or ML model.

19. The system of claim 18, wherein the configuration identifies a number of monitoring resource instants in the monitoring window.

20. The system of claim 18, wherein the at least one inference result comprises predicted beam information generated by the AI or ML model.

21. The system of claim 18, wherein the performance monitoring report includes a beam-accuracy indicator (BAI) based on whether a predicted beam matches a measured beam.

22. The system of claim 18, wherein the performance monitoring report includes information indicating whether a top-M predicted beams set is within a top-N measured beams set, where M and N are configured values.

23. The system of claim 18, wherein processing the performance metric comprises determining whether a predicted beam is outside a configured subset of beams used for monitoring.
